(19) United States
(12) Patent Application Publication
(10) Pub. No.: US 2005/0140035 A1
(43) Pub. Date: Jun. 30, 2005

(54) Refractory articles and methods for producing refractory articles

(76) Inventor: Kassim Juma, Staffordshire (GB)

Correspondence Address: SMITH-HILL AND BEDELL, 12670 N W BARNES ROAD, SUITE 104, PORTLAND, OR, 97229, US

(21) Appl. No.: 10/503,195

(22) PCT Filed: Jan. 30, 2003
(86) PCT No.: PCT/GB03/00382

(30) Foreign Application Priority Data
Feb. 1, 2002 (GB) 0202311.7

(51) Int. Cl. B29B 9/00

(52) U.S. Cl. 264/6; 264/13; 264/661; 264/604

(57) ABSTRACT

Refractory articles and methods for producing refractory articles are provided. One method comprises producing a mix of particulate pitch, ceramic filler and water, spray drying the mix, pressing the spray dried mix to form an intermediate product and heating the intermediate product to product a refractory article comprising graphitisable carbon bond.

The present invention relates to refractory articles and methods for producing refractory articles, in particular black refractory articles.

During the processing of steel, various refractory items such as ladle shrouds, stoppers, submerged entry nozzles and submerged entry shrouds are used to protect the steel flow from oxidation by air and otherwise used during steel formation and processing techniques. Such items are usually made of iso-statically pressed carbon bonded alumina-graphite, zirconia graphite and magnesia graphite. These are generally termed Black refractory articles.

Conventionally, such carbon bonding refractories are produced by mixing phenolic resin with ceramic powder, such as alumina, zirconia or magnesia, graphite and other additives such as glass frit and metallic powders, such as silicon and aluminium. Hexamethylene tetraamine is also added to cross link the phenolic resin. High intensity mixing is generally required to homogenise such mixes, and the homogenised mix then passed through a dryer to dry off the excess solvent to produce granules. The granules are then generally pressed into the shape of the desired article. Following pressing, the articles are placed in an oven and heated to about 200-250° C. for approximately 24 hours in order to temper the article by converting the phenolic resin from a thermoplastic to a thermostatic material by cross-linking reaction with the hexamethylene tetraamine.

Following these stages, the article is fired at temperatures between 700° C. and 1000° C. in order to pyrolysis the resin and form a carbon bond network that gives the article its characteristic refractory properties of relatively good resistance to thermal shock, corrosion and erosion from steel flow and good mechanical toughness. However the nature of the carbon bond produced in this way is a glassy carbon which has relatively low oxidation resistance and lower thermal shock resistance compared to the graphatisable type of carbon bond usually obtained from pyrolyisis of tar pitch, using similar processes.

However, these conventional processes of producing black refractory products suffer from a number of significant disadvantages. Phenolic resin and pitch are both hazardous to the environment and to people processing the materials. Furfuryl alcohol which is the usual liquid present in the phenolic resin is carcinogenic, as is tar pitch. The process for driving off the solvent to produce the granules is difficult to control, and the mix has a limited shelf life. It is also found that the quality of finished articles is not consistent and the heating stage for pyrolysis is very difficult to control due to the evolution of flammable gases. The process is long, taking over 72 hours from start to finish and can only be processed in batches. The carbon yield of phenolic resin is low, usually less than 50%.

According to the present invention there is provided a method for producing a refractory article, the method comprising producing a mix of particulate pitch, ceramic filler and water, spray drying the mix, forming the spray dried mix into an intermediate product and heating the intermediate product to produce a refractory article comprising graphitisable carbon bond.

Preferably the mix is produced in the form of a slurry and is generally homogenous. The particulate pitch used is preferably in powder form and desirably a high melting carbon bond pre-cursor. The pitch may comprise CARBORES a material supplied by RUTGERS VFT AG of Castrop-Rauxel, Germany.

The ceramic filler used may comprise one or more of alumina, zirconia, magnesia. The mix may further comprise one or more of silicon carbide, anti-oxidant, metallic powder, glass frit, preservative material, stabilising material, anti-bacterial material, tabular alumina, mullite, silica, chromite, clay talc, mica, silicon carbide, silicon nitride, zirconium diboride, titanium diboride, boron metal powder, magnesium metal powder, aluminium metal powder, boron carbide.

Preferably the mix is spray dried in spray drying apparatus, which may be of conventional design.

The mix is preferably spray dried to produce granules, which are preferably free flowing.

The granules are preferably pressed desirably at ambient temperature, preferably in an iso-static press.

The intermediate product is preferably heated to temperatures in the order of 700° C. to 1000° C., for between approximately 0.1 and 3 hours, desirably to fire the product to produce graphitisable carbon bonds in the article. Preferably heating is carried out generally in the absence of air. Alternatively or in addition the intermediate product may be glazed to protect from oxidation during pyrolysis.

The method is preferably carried out continuously and may be automated.

According to a further aspect of the present invention there is provided a method for producing granules for use in the production of refractory articles, the method comprising producing a mix of particulate pitch, ceramic filler and water and spray drying the mix.

According to a further aspect of the present invention there is provided a refractory article produced according to the methodology described above in any of the preceding nine paragraphs.

The invention further provides granules for use in the production of refractory articles, the granules being produced and being substantially as described in any of the preceding ten paragraphs.

Preferred embodiments of the present invention will now be described by way of example only.

The invention provides refractory articles and methods for producing refractory articles. One method comprises producing a mix of particulate pitch, ceramic filler and water, spray drying the mix, pressing the spray dried mix to form an intermediate product and heating the intermediate product to produce a refractory article comprising graphitisable carbon bond.

In more detail, the particulate pitch used is a high melting carbon pre-cursor and in these particular embodiments the pitch powder supplied by RUTGERS VFT SA of Kekulestrasse3, D-44579 Castrop-Rauxel, Germany under the brand CARBORES is particularly suitable. The general properties of this powder are; glass transition temperature (TMA) 213° C., Coking value (ISO 6998) 85.5%, Benzo[a]pyrene{HPLC} 125 mg/kg.

The ceramic filler used is one or more of alumina, zirconia and magnesia. Graphite powder is also added, of particule size generally less than 2 mm.

Further additives may be included in the mix, including one or more of silicon carbide, anti-oxidants, metallic powders, glass frit, preservative material, stabilising material, anti-bacterial material, tabular alumina, mullite, silica, chromite, clay talc, mica, silicon nitride, zirconium diboride, titanium diboride, boron metal powder, magnesium metal powder, aluminium metal powder, boron carbide.

Water is added in sufficient quantities to produce a slurry, the slurry being mixed until the mixture is generally homogenous.

The slurry mix is then granulated by spray drying the mixture in a conventional spray drying tower. The granular particles formed are then collected for pressing to form an intermediate product. An iso-static press is used to form the intermediate product. The intermediate product is then fired at temperatures in the order of 700° C. to 1000° C. for between 0.1 and 3 hours to cause graphitisable bonds to be formed to produce the refractory article. Firing for one hour has been found to produce satisfactory products. There is no requirement to temper the intermediate product, as is required in the conventional technique for tar pitch and phenolic resin. Preferably firing is carried out in the absence of air or alternatively the intermediate product is glazed to protect it from oxidation during pyrolysis.

This process has many other advantages over the aforementioned prior art. The nature of the process means that it can be continuous and does not require to be a batch process. The methodology could be fully automated to provide for continual production of refractory articles.

Further advantages are that the materials used, in particular the particulate pitch is considerably less hazardous than conventional tar pitch or phenolic resin and the spray drying process is considerably more controllable than the drying processes involved in conventional techniques. The granules also have a longer shelf life than conventional tar pitch/phenolic resin mixes and the quality of the finished article has proven to be more consistent than that from the conventional technique.

Graphitisable carbon bond generally has better oxidation resistance and superior thermal shock resistance than glassy carbon obtained from phenolic resin.

The methodology of the present invention is also considerably quicker than the conventional processes.

Below are examples of mixes that can be used in accordance with the present invention.

1. Alumina-Graphite mix

| | |
|---|---|
| Brown Fused alumina | 0-80% |
| Calcined alumina | 0-80% |
| Carbores | 0-50% |
| Silicon metal | 0-50% |
| Glass frit | 0-50% |
| Clay materials | 0-80% |

2. Zirconia-Graphite mix

| | |
|---|---|
| Zirconia (ZrO²) | 0-80% |
| Silicon carbide | 0-30% |
| Carbores | 0-50% |
| Silicon metal | 0-50% |
| Glass frit | 0-50% |
| Clay materials | 0-80% |

3. Magnesia-Graphite mix

| | |
|---|---|
| MgO | 0-80% |
| Silicon carbide | 0-30% |
| Carbores | 0-50% |
| Silicon metal | 0-50% |
| Glass frit | 0-50% |
| Clay materials | 0-80% |

The following are three specific examples of mixes which have been used in accordance with the present invention to produce black refractory articles.

Alumina-Graphite mix

| | |
|---|---|
| Brown Fused alumina | 35% |
| Calcined alumina | 20% |
| Graphite | 20% |
| Carbores | 5% |
| Feldspar | 4% |
| Silicon metal | 4% |
| Glass frit | 2% |

Zirconia-Graphite mix

| | |
|---|---|
| Fused Zirconia | 79% |
| Graphite | 5% |
| Carbores | 4% |
| Frit | 1% |
| Silicon metalpowder | 4% |

Magnesia-Graphite mix

| | |
|---|---|
| Fused Magnesia powder | 70% |
| Graphite | 13% |
| Silicon metalpowder | 4% |
| Glass frit | 2% |
| Carbores | 4% |

Various modifications may be made to the above described embodiment without departing from the scope of the invention. CARBORES may be replaced by one or more other pitches, and further may be used in conjunction with one or more other pitches.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-27. (canceled)

28. A method for producing a refractory article, the method comprising producing a mix of particulate pitch, ceramic filler and water, spray drying the mix, forming the spray dried mix into an intermediate product and heating the intermediate product to produce a refractory article comprising graphitisable carbon bond.

29. A method as claimed in claim 28, in which the mix is produced in the form of a slurry.

30. A method as claimed in claim 28, in which the mix is generally homogenous.

31. A method as claimed in claim 28, in which the particulate pitch used is in powder form.

32. A method as claimed in claim 28, in which the particulate pitch is a high melting carbon bond pre-cursor.

33. A method as claimed in claim 28, in which the pitch comprises CARBORES a material supplied by RUTGERS VFT AG of Castrop-Rauxel, Germany.

34. A method as claimed in claim 28, in which the ceramic filler used comprises one or more of alumina, zirconia, magnesia.

35. A method as claimed in claim 28, in which the mix further comprises one or more of silicon carbide, anti-oxidant, metallic powder, glass frit, preservative material, stabilizing material, anti-bacterial material, tabular alumina, mullite, silica, chromite, clay talc, mica, silicon carbide, silicon nitride, zirconium diboride, titanium diboride, boron metal powder, magnesium metal powder, aluminium metal powder, boron carbide.

36. A method as claimed in claim 28, in which the mix is spray dried in spray drying apparatus.

37. A method as claimed in claim 36, in which the apparatus used is of conventional design.

38. A method as claimed in claim 36, in which the mix is spray dried to produce granules.

39. A method as claimed in claim 36, in which the mix is spray dried to be free flowing.

40. A method as claimed in claim 38, in which the granules are pressed.

41. A method as claimed in claim 40, in which the granules are pressed at ambient temperature.

42. A method as claimed in claim 40, in which the granules are pressed in an isostatic press.

43. A method as claimed in claim 28, in which the intermediate product is heated to temperatures in the order of 700° C. to 1000° C., for between approximately 0.1 and 3 hours, to fire the product to produce graphitisable carbon bonds in the article.

44. A method as claimed in claim 28, in which heating is carried out generally in the absence of air.

45. A method as claimed in claim 28, in which the intermediate product is glazed to protect from oxidation during pyrolysis.

46. A method as claimed in claim 28, in which the method is carried out continuously.

47. A method as claimed in claim 28, in which the method is automated.

48. A method for producing granules for use in the production of refractory articles, the method comprising producing a mix of particulate pitch, ceramic filler and water and spray drying the mix.

49. A refractory article produced by a method comprising producing a mix of particulate pitch, ceramic filler and water, spray drying the mix, forming the spray dried mix into an intermediate product and heating the intermediate product to produce a refractory article comprising graphitisable carbon bond.

50. Granules for use in the production of refractory articles, the granules being produced by a method comprising producing a mix of particulate pitch, ceramic filler and water and spray drying the mix.
